(19) United States
(12) Patent Application Publication
(10) Pub. No.: US 2006/0026992 A1
(43) Pub. Date: Feb. 9, 2006

(54) Mold and method for making glass aspherical lenses

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/198,373

(22) Filed: Aug. 5, 2005

(30) Foreign Application Priority Data
Aug. 6, 2004 (CN) 200410051041.X

(51) Int. Cl. C03B 40/02; C03B 11/08

(52) U.S. Cl. 65/24; 65/374.12; 65/374.11; 65/374.15; 65/32.5; 65/117; 65/169

(57) ABSTRACT

A mold (20) for molding glass aspherical lenses includes a top core insert (201) and a bottom core insert 202. The top core insert and the bottom core each include a substrate (2001), an adhesive layer (2002) deposited on the substrate and a release film (2003) formed on the adhesive layer and acting as a molding surface (203). A method for manufacturing glass aspherical lenses includes the following steps: providing the above mold some glass masses (40); cleaning the glass masses by using an ionization device; putting one of the cleaned glass masses in the mold; heating the mold until the glass mass to become melted, introducing an inert gas into the mold; pressuring the mold to form the melted glass mass into a molded lens; cooling the molded lens by inert gas; and removing the molded lens from the mold to anneal and clean.

### FIELD OF THE INVENTION

The present invention relates to a mold for making aspherical lenses, and also relates to a method for making aspherical lenses.

### GENERAL BACKGROUND

Aspherical lenses are optical elements commonly used in digital cameras or digital videos. Aspherical lenses are capable of providing improved imaging quality, and correcting image distortion of wide-angle lenses. In addition, a single aspherical lens can be used to compensate image aberration caused by a spherical lens set. The aspherical lens can be used to simplify the configuration of the spherical lens set, thereby reducing the overall size of the camera.

Nowadays, aspherical lenses are generally made by an injection molding process or a glass molding process. Injection molding is mainly used for making plastic aspherical lenses. The development of the injection molding process mainly concentrates on the composition material of the mold and the process for manufacturing molds. The glass molding process is generally used for making glass aspherical lenses. The process for making glass aspherical lenses is relatively complex. However, the glass aspherical lenses obtained by the glass molding process generally have an optical quality better than the plastic aspherical lenses obtained by the injection molding process, especially as regards resolution.

Referring to FIG. 3 and FIG. 4, a conventional method for making glass aspherical lenses using a conventional mold includes the following steps: firstly, providing a mold 10, an infrared heater (not shown) and some glass masses (not shown), the mold 10 including a top core insert 11, a bottom core insert 12, and a release film 131 formed on the insert 11, 12 to act as a molding surface 13 of the mold 10; secondly, placing one of the glass masses between the top core insert 11 and the bottom core insert 12, and making the molding surface 13 of the mold 10 come into contact with the glass mass; thirdly, heating the mold 10 using an infrared heater, until the glass mass is melted; fourthly, pressuring the top core insert 11 and/or the bottom core insert 12 to each other so as to form the melted glass mass into a molded lens; fifthly, cooling the mold 10 and the molded lens; and sixthly, removing the molded lens from the mold 10.

In the above-described process, the molding surface 13 of the mold 10 is prone to be scratched or damaged. Therefore a surface of the molded lens made by the mold 10 may have unsatisfactory precision and inferior quality. The molding surface 13 is directly covered with a release film 131. The release film 131 is prone to be oxidized. Thus, the service lifetime of the mold 10 may be shortened. In addition, it can still be difficult to remove the duly formed molded lens from the mold 10 even with the release film 131 provided. Furthermore, the molded lens obtained by the method may have unduly high internal stress, which may adversely affect the machinability and optical quality of the molded lens. In view of the above shortcomings, the process may not be considered to be suitable for mass production of certain glass aspherical lenses.

What is needed, therefore, is a mold which has a long service lifetime, and can yield high quality glass aspherical lenses. What is also needed is a related method for making glass aspherical lenses.

### SUMMARY

In a preferred embodiment herein, a mold for molding glass aspherical lenses includes a top core insert and a bottom core insert. The top core insert and the bottom core each includes a substrate, an adhesive layer deposited on the substrate, and a release film formd on the adhesive layer and acting as form a molding surface.

Another preferred embodiment provides a method for manufacturing glass aspherical lenses. The method includes the following steps: providing a glass mass; cleaning the glass mass using an ionization device; putting the glass masses in the ionization equipment to clean; providing a mold, the mold comprising a top core insert and a bottom core insert; placing the cleaned glass mass between the top core insert and the bottom core insert of the mold; heating the mold by using a heater, so as to cause the glass mass to become melted; introducing an inert gas into the mold; pressuring the top core insert and/or the bottom core insert to form the melted glass mass into a molded lens; cooling the molded lens in an inert gas environment; removing the molded lens from the mold to anneal; and cleaning the molded lens.

Because an adhesive layer is added between the substrate and the release film, the mold has a long service lifetime. In addition, the glass masses are cleaned in the ionization equipment before molding and using the inert gas producer to add some inert gas in the mold, so the mold lens can be easy release from the mold. Furthermore, anneal the molded lens, thus the inner stress producing in the molding process can be eliminated. Therefore, the mold and process can make glass lens with fine quality and high precision.

Other advantages and novel features will become more apparent from the following detailed description of preferred embodiments when taken in conjunction with the accompanying drawing, in which:

### BRIEF DESCRIPTION OF THE DRAWINGS

FIG. 1 is a schematic, cross-sectional view of a mold for molding glass lenses in accordance with a preferred embodiment of the present invention;

FIG. 2 is a flow chart of a method for molding glass lenses in accordance with another preferred embodiment of the present invention;

FIG. 3 is a schematic cross-sectional view of a conventional mold; and

FIG. 4 is a flow chart of a conventional method for molding glass lenses.

### DETAILED DESCRIPTION OF PREFERRED EMBODIMENTS

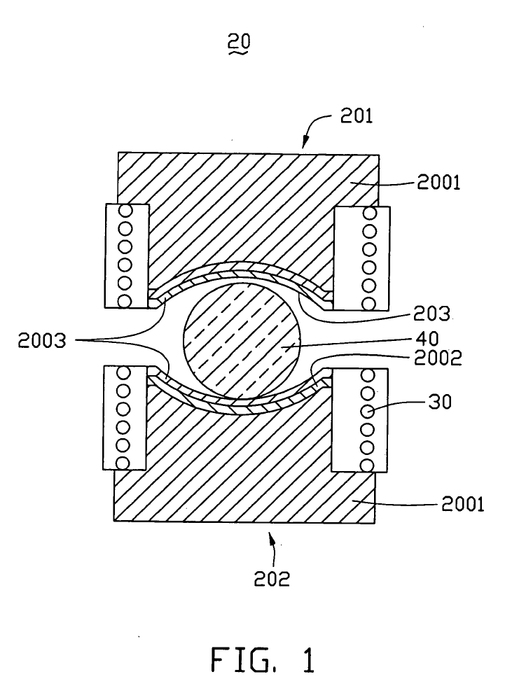

Referring to FIG. 1, in a preferred embodiment of the present invention, a mold 20 for molding glass aspherical lenses includes a top core insert 201 and a bottom core insert 202. The top core insert 201 and the bottom core insert 202 each comprise a substrate 2001, an adhesive layer 2002 deposited on the substrate 2001, and a release film 2003 formed on the adhesive layer 2002 and acting as a molding surface 203.

The substrate 10 can be made of one of stainless steel, silicon carbide (SiC), and tungsten carbide (WC). The adhesive layer 2002 is for facilitating the release film 2003 to firmly adhere to the substrate 2001, and for improving the machinability of the mold 20. In the case of the substrate 10 being made of silicon carbide, the adhesive layer 2002 is preferably made of silicon. In the case of the substrate 10 being made of tungsten carbide, the adhesive layer 2002 is preferably made of carbon. The release film 2003 is for ensuring high molding precision of glass material, and for preventing the glass material from adhering to the mold 20. The release film 2003 can be made of amorphous carbon, a hard ceramic material such as silicon carbide or silicon nitride (Si₃N₄), a noble metal alloy mainly including platinum (Pt), iridium (Ir) or ruthenium (Ru), and so on.

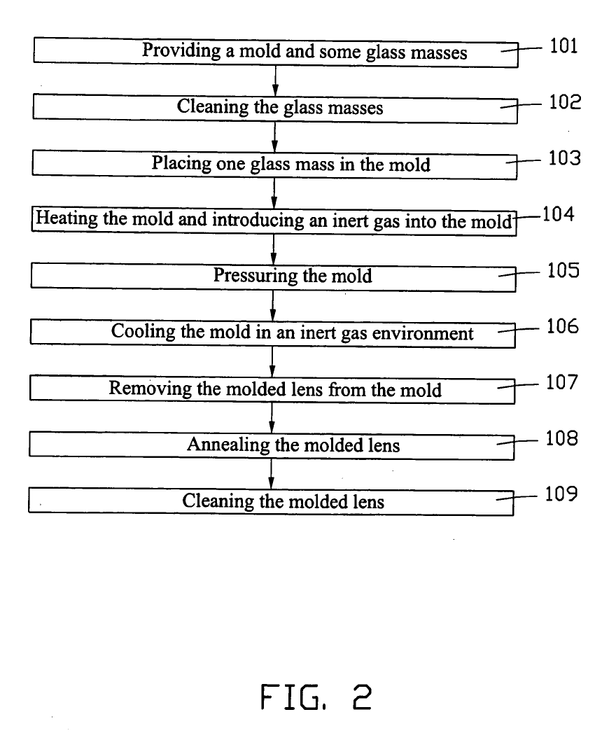

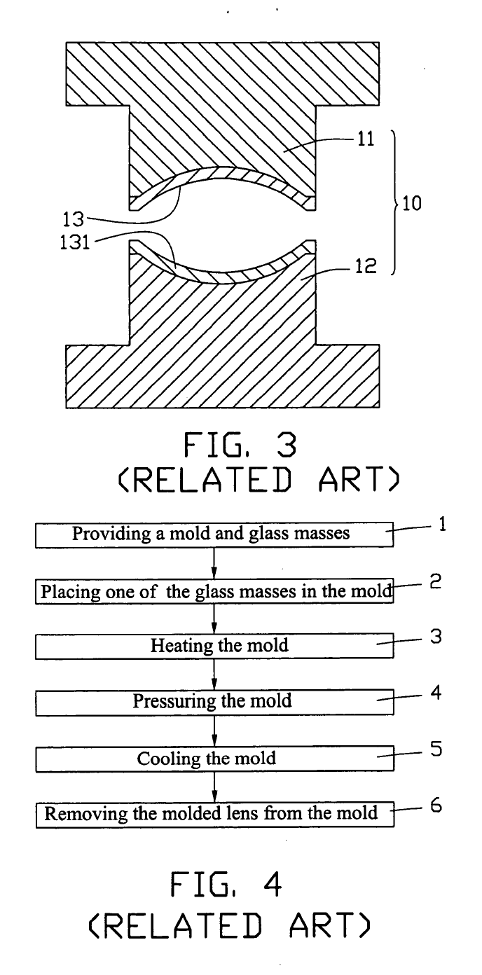

Referring to FIG. 2, a method for manufacturing glass aspherical lenses comprises the following steps. In step 101, a mold 20 and a plurality of glass masses 40 are provided. In step 102, the glass masses 40 are cleaned by an ionization device. The ionization device may be a plasma etching device. In this step, any impurities carried by the glass masses 40 can be cleansed. In step 103, one of the cleaned glass masses 40 is placed between the top core insert 201 and the bottom core insert 202. The molding surface 203 of the mold 20 is brought into contact with the glass mass 40. In step 104, the mold 20 is heated up using an infrared heater 30, until the glass mass 40 is melted. The infrared heater 30 is generally arranged around the mold 20. A temperature of the glass mass 40 generally reaches up to 600° C. Then, an inert gas such as argon (Ar) gas is introduced into the mold 20 by an inert gas supplying device. In step 105, the top core insert and/or the bottom core insert are pressed to each other by a force of about 10 KN, so as to form the glass mass 40 into a molded lens. In step 106, the molded lens is cooled in an inert gas environment. In step 107, the molded lens is removed from the mold 20. In step 108, the molded lens is annealed to reduce or eliminate any internal stress generated during the molding process. In step 109, the molded lens is cleaned.

The adhesive layer 2002 provided between the substrate 2001 and the release film 2003 ensures a long service lifetime of the mold 20. In addition, the glass mass 40 are cleansed by the ionization device prior to the molding process, and the inert gas is introduced into the mold 20. These measures ensure that the formed molded lens can be readily removed from the mold 20. Furthermore, after the molded lens is annealed, any internal stress generated during the molding process can be effectively eliminated. Therefore, the mold 20 and the related process can be utilized to make fine quality, high precision glass lenses.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A mold for molding glass aspherical lenses, comprising:
a top core insert; and
a bottom core insert;
wherein the top core insert and the bottom core each comprise a substrate, an adhesive layer provided on the substrate, and a release film provided on the adhesive layer.

2. The mold as claimed in claim 1, wherein the release film is made of a noble metal alloy.

3. The mold as claimed in claim 1, wherein the noble metal alloy is platinum (Pt), iridium (Ir), or ruthenium (Ru).

4. The mold as claimed in claim 2, wherein the substrate is made of silicon carbide (SiC).

5. The mold as claimed in claim 4, wherein the adhesive layer is made of silicon (Si).

6. The mold as claimed in claim 2, wherein the substrate is made of tungsten carbide (WC).

7. The mold as claimed in claim 6, wherein the adhesive layer is made of carbon (C).

8. A method for manufacturing a glass aspherical lens, comprising the following steps:
providing a glass mass;
cleaning the glass mass by using an ionization device;
providing a mold, the mold comprising a top core insert and a bottom core insert;
placing the cleaned glass mass between the top core insert and the bottom core insert of the mold;
heating the mold by using a heater, so as to cause the glass mass to become melted;
introducing an inert gas into the mold;
pressuring the top core insert and/or the bottom core insert to form the melted glass mass into a molded lens;
cooling the molded lens in an inert gas environment;
removing the molded lens from the mold;
annealing the molded lens; and
cleaning the molded lens.

9. The method as claimed in claim 8, wherein one of the top core insert and the bottom core insert of the mold includes a substrate, an adhesive layer formed on the substrate, and a release film formed on the adhesive layer.

10. The method as claimed in claim 8, wherein the inert gas is argon (Ar).

11. The method as claimed in claim 8, wherein the heater is an infrared heater.

12. The method as claimed in claim 8, wherein the ionization device is a plasma etching device.

13. A method for manufacturing a glass lens, comprising the following steps:
preparing a mold defining a space therein;
placing a glass mass in said space of said mold;
heating said glass mass in said space;
introducing inert gas into said space around said glass mass;
pressing said glass mass into a shape of a glass lens by means of said mold; and
cooling said pressed glass mass down in said inert gas in said space to acquire said glass lens releasable from said mold.

14. The method as claimed in claim 13, further comprising the step of cleaning said glass mass by means of an ionization device before said placing step.

15. The method as claimed in claim 13, further comprising the step of annealing said pressed glass mass after said cooling step.
